(19) United States
(12) Patent Application Publication
(10) Pub. No.: US 2006/0082027 A1
(43) Pub. Date: Apr. 20, 2006

(54) In-line vacuum device for pulling a vacuum

(76) Inventors: Scott A. Durbin, Uniontown, OH (US); Braden S. Westfall, Massillon, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/966,517

(22) Filed: Oct. 15, 2004

(51) Int. Cl. B29C 35/00

(52) U.S. Cl. 264/326

(57) ABSTRACT

An in-line vacuum device for pulling a vacuum includes an inlet and outlet in-line with a drain conduit. The vacuum device further includes a jet inlet and jet hoses and jet nozzles. The jet nozzles point downstream toward the outlet of the vacuum device, and by introducing fluid through the jet inlet, jet hoses, and jet nozzles, a vacuum is created at the inlet side of the device, thus drawing the contents of the drain conduit donwstream and creating a vacuum upstream. The in-line vacuum valve finds particular application in draining the bladder in a tire press.

### BACKGROUND OF THE INVENTION

The present invention generally relates a device for pulling a vacuum, and, in a particular embodiment and application, to an in-line vacuum device for emptying the contents of a tire press bladder that is used to force raw rubber material into the press and facilitate vulcanization of the rubber.

In the tire and rubber industry, hydraulic and mechanical presses are often used to vulcanize rubber products being manufactured. In the tire industry specifically, a rubber vessel called a bladder is used to force raw rubber material in the form of a “green tire” into a tire mold to take on a desired tire and tread shape. In order to accomplish this, the bladder is filled with steam, and the steam both expands the bladder to force the rubber material into the mold and heats up the rubber to bring it to its vulcanization temperature. At the end of the vulcanization period for a given tire, the bladder is lowered out of the way so that the cured tire can be removed and a new green tire can be placed into the press.

When the cure is complete, a valve associated with the bladder is opened to reduce the pressure inside the bladder to atmospheric pressure. At atmospheric pressure, the bladder is still slightly expanded, and condensate from the steam may exist inside the bladder. If the bladder were lowered in this state, it may be damaged by being pinched between the platen walls and the center-mechanism. If any condensate remains in the bladder when it is used in a subsequent molding and vulcanization process, new steam introduced for molding and vulcanization will cause the condensate to flash, resulting in a large increase in pressure that can cause the bladder to be damaged or even explode. To prevent this from happening, it is important to collapse the bladder and draw out substantially all condensate.

To accomplish this, a siphon valve, also called an injector, is used. The siphon valve uses a high-pressure fluid forced through a nozzle and directed into a plenum. A vacuum line is attached off the side of this plenum, usually at 90 degrees thereto, and the high velocity fluid passing by the opening of the vacuum line creates a low pressure. The pressure created is less than atmospheric, and the bladder is thereby drawn inward and collapsed, allowing the assembly to be lowered without damage. After lowering, the siphon valve and vacuum line are shut off. Although this system is very effective in achieving the desired goal of emptying the bladder, all other valves in the system must be shut before the vacuum can be created, thus requiring additional steps. Also, with this set-up, additional valves and piping are necessary.

Central vacuum systems have also been used to achieve the desired goal of emptying the bladder. In such a system, a dedicated line is run through the plant to pull the desired negative pressure. This system is effective in pulling a vacuum, but the cost of operating and maintaining the system is high. Additionally, the condensate that is pulled using this system generally cannot be recycled, thus creating waste.

There is a need in the art for a in-line vacuum device and method for use in emptying a bladder of a tire mold, wherein the device and method eliminate both the excess valves and piping and reduces the time needed to draw in the bladder as compared to prior art processes.

### SUMMARY OF THE INVENTION

In general, the present invention provides an in-line vacuum device including a body portion having a conduit defining an inlet and an outlet thereof; and at least one jet nozzle directing a stream of fluid from a point external of said body portion into said conduit in the direction of said outlet to create a vacuum at said inlet.

This invention also provides a method for drawing fluid out of a bladder in a tire press comprising the steps of providing a drain pipe communicating with said bladder; providing an in-line vacuum device in said drain pipe, said in-line vacuum device comprising a body portion having a conduit defining an inlet and an outlet thereof, said inlet and said outlet being in-line with the drain pipe; and at least one jet nozzle directing a stream of fluid from a point external of said body portion into said conduit in the direction of said outlet to create a vacuum at said inlet, wherein said inlet ultimately communicates with the interior of said bladder through said drain pipe, and the vacuum created at said inlet draws substantially all fluid and gas out of the bladder and through said body portion; and introducing a stream of fluid through said at least one jet nozzle to create the vacuum and draw substantially all fluid and gas out of the bladder.

### BRIEF DESCRIPTION OF THE DRAWINGS

FIG. 1 is a top plan view of an in-line vacuum device in accordance with this invention;

FIG. 2 is a side view of the in-line vacuum device of FIG. 1;

FIG. 3 is a cross-sectional view of the device of FIGS. 1 and 2, with jet hose portions removed; and

FIG. 4 is a general piping schematic of a tire curing press and related pipes and valves, and shows the use of an in-line vacuum device of this invention in such an environment.

### BRIEF DESCRIPTION OF THE PREFERRED EMBODIMENTS

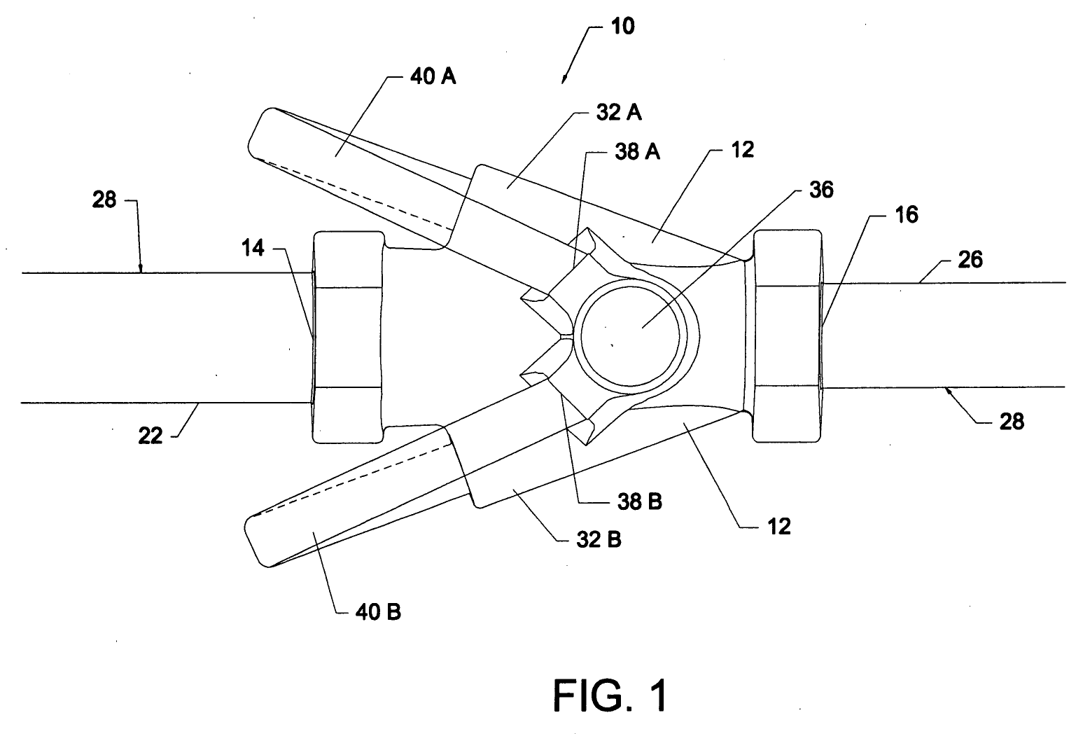

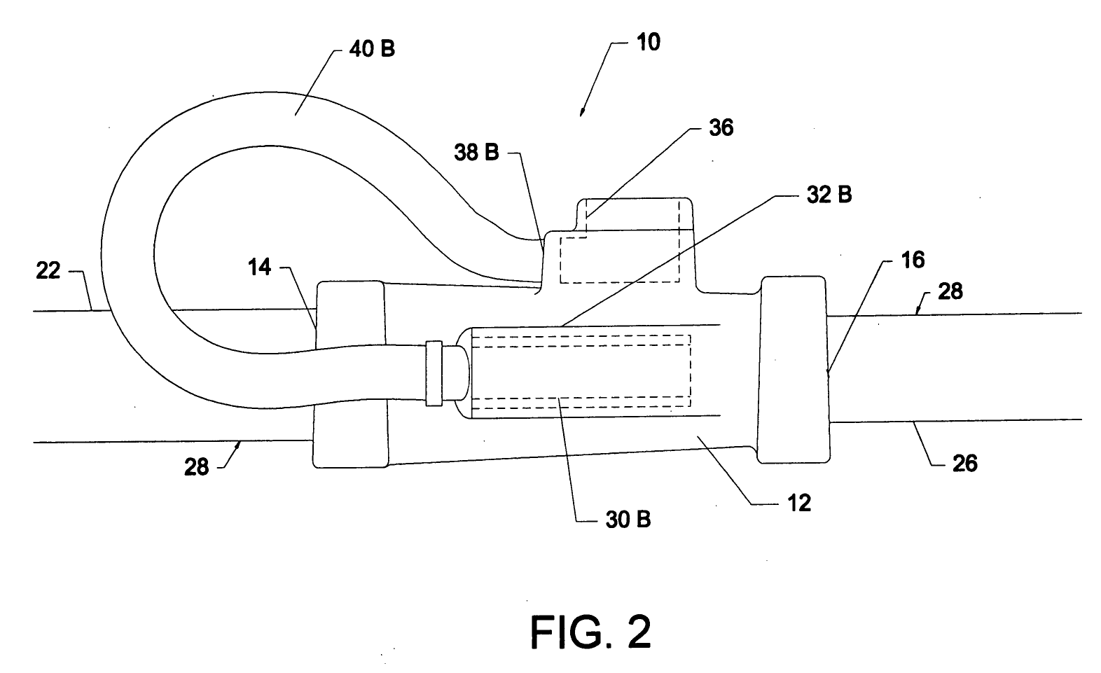

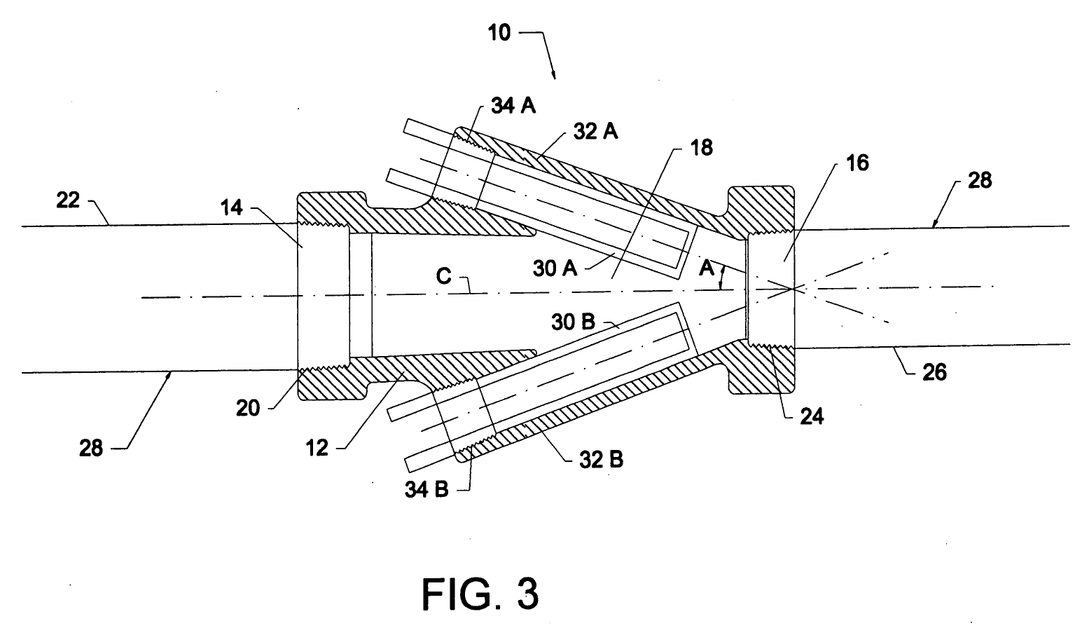

With reference to FIGS. 1-3, it can be seen that an in-line vacuum device according to this invention is shown and designated by the numeral 10. Vacuum device 10 includes body portion 12 having an inlet 14 and outlet 16 defined by conduit 18. Preferably, inlet 14 and outlet 16 are coaxial, as at center line C of conduit 18 and the drain pipe (FIG. 3). Threads 20 at inlet 14 are provided to fix body portion 12 on an inlet pipe 22, and threads 24 are provided at outlet 16 to fix body portion 12 to an outlet pipe 26. Inlet pipe 22, outlet pipe 26, and conduit 18 of body portion 12 form a drain pipe 28, and in-line vacuum device 10 is thus considered to be in-line with drain pipe 28. In-line vacuum device 10, in drain pipe 28, serves to draw a vacuum in virtually any process and apparatus in which vacuum is required, and, in a particular embodiment in which the device 10 has been successfully employed, serves to draw fluid out of a bladder of a tire press. This particular embodiment will be explained more fully below.

First jet nozzle 30a and second jet nozzle 30b are retained in nozzle ports 32a, 32b, respectively. First and second jet nozzles 30a, 30b are shown in the figures as being separate nozzle elements that engage nozzle ports 32a, 32b at threads 34a, 34b, but it will be appreciated that the present invention is not limited thereto or thereby. Jet nozzles 30a, 30b direct fluid, typically either water or steam, toward outlet 16, at high velocity, in order to create a vacuum at inlet 14. The fluid is fed to jet inlet 36, which does not communicate with conduit 18 (i.e., the interior) of body portion 12, but rather has first and second outlets 38a, 38b that communicate with first and second jet hoses 40a, 40b. First and second jet hoses 40a, 40b communicate respectively between jet inlet 36 and their respective jet nozzle 30a, 30b. Thus, fluid introduced at jet inlet 36 is split, with a portion traveling through first jet hose 40a and the remainder traveling through second jet hose 40b. The fluid forced through jet hoses 40a, 40b travels at high velocity and is at a high pressure, and therefore introduces a fluid stream at high pressure within drain pipe 28, at a position proximate outlet 16 of in-line vacuum device 10. The individual streams preferably intersect proximate outlet 16 and present enough fluid to fill drain pipe portion 26 (outlet pipe 26).

This device 10 may be employed in virtually any process in which a vacuum is to be pulled. In a particular process embodiment, this high velocity, high pressure stream of fluid is directed downstream of the bladder of a tire press, and creates a vacuum upstream, such that, by introducing fluid at high pressure at jet inlet 36, the bladder of the tire press can quickly be emptied. Although two jet nozzles have been employed in the preferred embodiment herein, it should be appreciated that at least one jet nozzle may be employed, and, alternatively, more than two jet nozzles may be employed. It should also be appreciated that, while jet inlet 36 is provided in a fitment on body portion 12, it would be possible to introduce fluid to jet nozzles 30a, 30b in another manner from a point external of body portion 12 into the conduit 18 thereof.

In particularly preferred embodiments, first and second jet nozzles 30a, 30b introduce fluid into drain pipe 28 at an angle of from greater than zero to about 45 degrees off of the central axis C. This angle is shown as angle A in FIG. 3. In other embodiments, the angle A ranges from about 10 to 30 degrees, and in yet other embodiments, from about 15 to 25. In a particular embodiment successfully employed in a tire press, the angle A was 20 degrees.

Jet nozzles 30a, 30b include outlets 31a, 31b that necessarily have a cross sectional area. The sum of the cross sectional area of all jet outlets, such as 31a, 31b, is chosen based upon the nominal cross sectional area of the outlet pipe with which they ultimately communicate, such as outlet pipe 26. It should be recalled that this invention may have any of one or more jet nozzles, and, for purposes of the choosing of a cross sectional area for the jet nozzle outlets, it is the sum of the cross sectional area of all jet outlets that is important. For reasons of symmetry, when multiple jet nozzles are employed, they are preferable chosen to have identical cross sectional areas at their outlets.

Designating R1 as the cross sectional area of the outlet pipe, such as pipe 26, and designating R2 as the sum of the cross sectional area of all jet outlets, such as outlets 31a, 31b, the ratio of R1 to R2 is generally chosen to be from 7.5 to 18. In more particular embodiments, the ratio R1/R2 is chosen to be from 10 to 15. In yet other embodiments, the ratio is from 11 to 13, and, in a particular embodiment successfully employed in a tire press, the ratio was about 12.

The ratios expressed here have been found to be useful for water as the fluid directed through the jet nozzles. The ratio will change depending upon the properties (e.g., physical state, density, viscosity) of the fluid chosen for creating the vacuum.

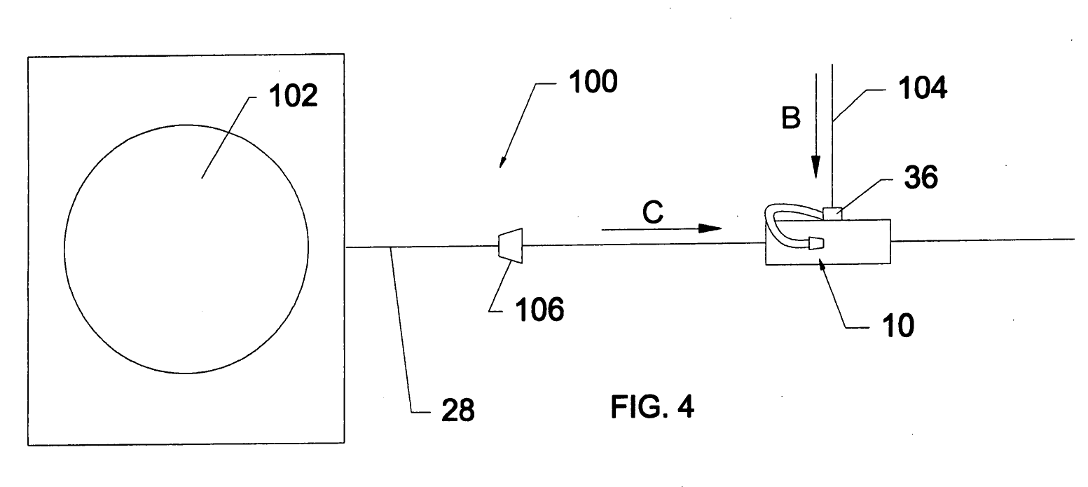

Referring now to FIG. 4, it can be seen that in-line vacuum device 10 may be employed as part of a tire curing press system 100 having a bladder 102 that must be drained as is generally appreciated. In-line vacuum device 10 is fixed to drain pipe 28, as already disclosed, and receives a supply of fluid at jet inlet 36, from a fluid supply line 104, in the direction of arrow B. The fluid is directed downstream (to the right in FIG. 4), as disclosed above, and creates a vacuum to drain bladder 102 in the direction of arrow C. To further aid in the creation of a sufficient vacuum, drain pipe, as at 106 may increase diameter proximate device 10.

While a full and complete description of the invention has been set forth in accordance with the dictates of the patent statutes, it should be understood that modifications can be resorted to without departing from the spirit hereof or the scope of the appended claims.

What is claimed is:

1. An in-line vacuum device comprising:
a body portion having a conduit defining an inlet and an outlet thereof; and
at least one jet nozzle directing a stream of fluid from a point external of said body portion into said conduit in the direction of said outlet to create a vacuum at said inlet.

2. The in-line vacuum device of claim 1, wherein said at least one jet nozzle includes first and second jet nozzles, with said first and second jet nozzles each directing a stream of fluid from a point external of said body portion into said conduit in the direction of said outlet, each said stream of fluid being directed into said conduit at an angle.

3. The in-line vacuum device of claim 2, wherein each said stream of fluid intersects at said outlet.

4. The in-line vacuum device of claim 3, wherein said outlet of said body portion connects to an outlet pipe and said streams of fluid fill said outlet pipe.

5. The in-line vacuum device of claim 2, further comprising:
a jet inlet in said body portion that receives a source stream of fluid, said source stream of fluid providing said streams of fluid directed to said outlet by said first and second nozzles;
a first jet hose communicating between said jet inlet and said first jet nozzle to direct a portion of said source stream of fluid from said jet inlet to said first jet nozzle;
a second jet hose communicating between said jet inlet and said second jet nozzle to direct a remainder of said source stream of fluid from said jet inlet to said second jet nozzle.

6. The in-line vacuum device of claim 1, wherein said conduit has a central axis, and stream of fluid directed into said conduit by said at least one jet nozzle is introduced at an angle of from greater than 0 to about 45 degrees off of said central axis.

7. The in-line vacuum device of claim 1, wherein said conduit has a cross sectional area and each of said at least one jet nozzle has an outlet with a cross sectional area, and the ratio of the cross sectional area of the conduit to the sum of the cross sectional area of each of said at least one jet nozzle is from 7.5 to 18.

8. A method for drawing fluid out of a bladder in a tire press comprising the steps of:
providing a drain pipe communicating with said bladder;
providing an in-line vacuum device in said drain pipe, said in-line vacuum device comprising:
a body portion having a conduit defining an inlet and an outlet thereof, said inlet and said outlet being in-line with the drain pipe; and
at least one jet nozzle directing a stream of fluid from a point external of said body portion into said conduit in the direction of said outlet to create a vacuum at said inlet, wherein said inlet ultimately communicates with the interior of said bladder through said drain pipe, and the vacuum created at said inlet draws substantially all fluid and gas out of the bladder and through said body portion; and
introducing a stream of fluid through said at least one jet nozzle to create the vacuum and draw substantially all fluid and gas out of the bladder.

9. The method of claim 8, wherein said at least one jet nozzle includes first and second jet nozzles, with said first and second jet nozzles each directing a stream of fluid from a point external of said body portion into said conduit in the direction of said outlet, each said stream of fluid being directed into said conduit at an angle.

10. The method of claim 9, wherein each said stream of fluid intersects at said outlet.

11. The method of claim 10, wherein said outlet of said body portion connects to an outlet pipe and said streams of fluid fill said outlet pipe.

12. The method of claim 9, further comprising:
a jet inlet in said body portion that receives a source stream of fluid, said source stream of fluid providing said streams of fluid directed to said outlet by said first and second nozzles;
a first jet hose communicating between said jet inlet and said first jet nozzle to direct a portion of said source stream of fluid from said jet inlet to said first jet nozzle;
a second jet hose communicating between said jet inlet and said second jet nozzle to direct a remainder of said source stream of fluid from said jet inlet to said second jet nozzle.

13. The method of claim 8, wherein said conduit has a central axis, and stream of fluid directed into said conduit by said at least one jet nozzle is introduced at an angle of from greater than 0 to about 45 degrees off of said central axis.

14. The in-line vacuum device of claim 8, wherein said conduit has a cross sectional area and each of said at least one jet nozzle has an outlet with a cross sectional area, and the ratio of the cross sectional area of the conduit to the sum of the cross sectional area of each of said at least one jet nozzle is from 7.5 to 18.

15. The in-line vacuum of claim 8, wherein the diameter of the drain pipe increases proximate the inlet of the conduit to create low pressure at the inlet of the conduit.
